(19) United States
(12) Patent Application Publication
(10) Pub. No.: US 2021/0188046 A1
(43) Pub. Date: Jun. 24, 2021

(54) ISOLATED EVAPORATOR PIPING POD

(71) Applicant: CARRIER CORPORATION, Palm Beach Gardens, FL (US)

(72) Inventor: Jason R. Kondrk, Clay, NY (US)

(21) Appl. No.: 17/057,305

(22) PCT Filed: Jun. 6, 2019
(86) PCT No.: PCT/US2019/035832

§ 371 Date: Nov. 20, 2020

Related U.S. Application Data
(60) Provisional application No. 62/693,166, filed on Jul. 2, 2018.

(51) Int. Cl. B60H 1/32; B65D 88/74

(52) U.S. Cl. CPC B60H 1/3229; B65D 88/745; B60H 1/3232

(57) ABSTRACT

A transport refrigeration unit (13) is provided and includes a wall (510) defining an inlet (511) and an outlet (512) and a pod (530) attachable to the wall (510) to define, with a portion of the wall, an interior configured to accommodate a heat exchange portion of a heat exchanger (520), a fan (550) that drives air flow from the inlet (511) and to the outlet (512) through the heat exchange portion. The pod (530) is configured to isolate coolant flow control elements (522) of the heat exchanger (520) from the interior.

### BACKGROUND

The following description relates to evaporators and, more specifically, to an isolated evaporator piping pod for certain refrigerants, such as A2L refrigerants.

Regulations in various regions around the world are requiring that refrigerant suppliers reduce distributions of high global warming potential (GWP) refrigerants. This presents an issue, however, in that new blends of low GWP refrigerants, such as A2L refrigerants, are often characterized as being mildly flammable. Thus, if an A2L refrigerant, for example, leaks into a cargo container interior through evaporator tubing, the leaked A2L refrigerant can create a mildly flammable environment that could ignite if a sufficient energy source exists.

While the potential ignition of leaked, mildly flammable refrigerant can be addressed by various options, such as the provision of safety systems, doing so is costly and time consuming.

### BRIEF DESCRIPTION

According to an aspect of the disclosure, a transport refrigeration unit (TRU) is provided and includes a wall defining an inlet and an outlet and a pod attachable to the wall to define, with a portion of the wall, an interior configured to accommodate a heat exchange portion of a heat exchanger, a fan that drives air flow from the inlet and to the outlet through the heat exchange portion and the air flow. The pod is configured to isolate coolant flow control elements of the heat exchanger from the interior.

In accordance with additional or alternative embodiments, the heat exchange portion includes evaporator tubes having first and second opposite ends and the coolant flow control elements include return bend elements that respectively connect corresponding ends of two or more evaporator tubes at one of the first and second opposite ends.

In accordance with additional or alternative embodiments, the pod defines a first aperture through which the first end of each of the evaporator tubes extends and a second aperture through which the second end of each of the evaporator tubes extends.

In accordance with additional or alternative embodiments, the pod defines first apertures through which the return bend elements associated with the first end extend and second apertures through which the return bend elements associated with the second end extend.

According to another aspect of the disclosure, a pod is provided for an evaporator including evaporator tubes and return bend elements connecting corresponding evaporator tube ends. The pod includes peripheral flanges which are attachable to a wall of a cargo area, a convex portion formed to define, with a portion of the wall, an interior to accommodate the evaporator tubes and a fan, the interior being fluidly communicative with the cargo area through an inlet and an outlet defined in the wall and the fan drives air flow from the inlet to the outlet and through the evaporator tubes and plate sections respectively secured to opposite end sections of the evaporator tubes and respective local portions of the peripheral flanges and the convex portion to isolate the return bend elements from the interior.

In accordance with additional or alternative embodiments, the return bend elements include return bends and brazed joints that connect the return bends to the corresponding ends of the two or more evaporator tubes.

In accordance with additional or alternative embodiments, the peripheral flanges form a polygonal profile and the convex portion includes rounded edges.

In accordance with additional or alternative embodiments, the interior includes a lower section defined between the inlet and the evaporator tubes, an upper section defined between the fan and the outlet and a central section defined between evaporator tubes and the fan.

In accordance with additional or alternative embodiments, respective outer planes of the plate sections are coplanar with respective outermost planes of the opposite end sections of the evaporator tubes or the plate sections are respectively formed to define apertures through which the return bend elements are connectable with the corresponding evaporator tube ends.

In accordance with additional or alternative embodiments, the plate sections respectively define, with respective distal portions of the peripheral flanges and the convex portion, distal interiors isolated from the interior and the distal portions of the convex portion define apertures through which the distal interiors are communicative with an exterior of the cargo area.

In accordance with additional or alternative embodiments, the convex portion includes removable panels.

According to another aspect of the disclosure, a transport refrigeration unit (TRU) is provided and includes a wall defining an inlet and an outlet between a cargo area and an exterior, an evaporator and a pod. The pod includes peripheral flanges attachable to the wall, a convex portion defining, with a portion of the wall, an interior communicative with the cargo area through the inlet and the outlet and configured to accommodate the evaporator and a fan that drives air flow from the inlet and to the outlet through the evaporator and plate sections respectively secured to opposite end sections of evaporator tubes of the evaporator and respective local portions of the peripheral flanges and the convex portion to divide the interior into a first interior configured to accommodate the evaporator tubes and the fan and second interiors isolated from the first interior and configured to accommodate return bend elements of the evaporator.

In accordance with additional or alternative embodiments, the return bend elements include return bends and brazed joints that connect the return bends to corresponding ends of the two or more evaporator tubes.

In accordance with additional or alternative embodiments, the peripheral flanges form a polygonal profile and the convex portion comprises rounded edges.

In accordance with additional or alternative embodiments, a width of the first interior is equal to or slightly less than a width of the evaporator tubes.

In accordance with additional or alternative embodiments, the first interior includes a lower section defined between the inlet and the evaporator tubes, an upper section defined between the fan and the outlet and a central section defined between evaporator tubes and the fan.

In accordance with additional or alternative embodiments, respective outer planes of the plate sections are coplanar with respective outermost planes of the opposite end sections of the evaporator tubes.

In accordance with additional or alternative embodiments, the plate sections are respectively formed to define apertures through which the return bend elements are connectable with the corresponding evaporator tubes.

In accordance with additional or alternative embodiments, the distal portions of the convex portion define apertures through which the second interiors are communicative with an exterior of the cargo area.

In accordance with additional or alternative embodiments, the convex portion includes removable panels.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features and advantages of the disclosure are apparent from the following detailed description taken in conjunction with the accompanying drawings in which:

FIG. 1 is a trailer with a transport refrigeration unit (TRU) in accordance with embodiments;

FIG. 2 is a graphical depiction of flammability vs. charge loss for various refrigerants;

FIG. 3 is a perspective view of a conventional pod for an evaporator of a TRU;

FIG. 4 is a side view of the conventional pod of FIG. 3;

FIG. 5 is a side view of a pod with isolation plates in an operational condition in accordance with embodiments;

FIG. 6 is a front view of the pod including the isolation plates of FIG. 5 in accordance with embodiments;

FIG. 7 is a cutaway front view of the pod including the isolation plates of FIG. 5 in accordance with embodiments;

FIG. 8 is a side view of plates of the pod of FIGS. 5 and 6 in accordance with embodiments;

FIG. 9 is a side view of plates of the pod of FIGS. 5 and 6 in accordance with embodiments;

FIG. 10 is a side view of a removable panel in accordance with embodiments;

FIG. 11 is a front view of a pod in accordance with alternative embodiments;

FIG. 12 is a side view of the pod of FIG. 11 in accordance with further alternative embodiments; and

FIG. 13 is a side view of the pod of FIG. 11 in accordance with further alternative embodiments.

These and other advantages and features will become more apparent from the following description taken in conjunction with the drawings.

### DETAILED DESCRIPTION

As will be described below, a pod is provided to isolate piping, valves, return bends and other brazed joints from exposure to the outdoor ambient section of a transport refrigeration unit. The pod includes an enclosure with covers so that if a leak occurs, the leaked fluid cannot be pulled into the air stream by the evaporator fan. A refrigerant and condensate drain would allow leaked fluid to flow out of the enclosed area to the outside of the cargo storage area.

With reference to FIG. 1, a trailer 10 is provided and is attachable to a truck for transportation of various goods. The trailer 10 includes a body 11 that defines an interior or a cargo area 12 in which the various goods can be stowed during transportation. To an extent that these goods need to be kept in an air conditioned environment, such as where the goods include perishable items, the trailer 10 may further include a transport refrigeration unit (TRU) 13. The TRU 13 is attachable a portion of the body 11, such as a front of the body 11, and is configured to draw heated air in from the cargo area 12, to cool the heated air and to exhaust cooled air back into the cargo area 12. Within the TRU 13, the cooling is accomplished by flowing the heated air over and across evaporator tubing of an evaporator. The evaporator tubing is charged with refrigerant at a lower temperature than the heated air such that, as the heated air flows over and across the evaporator tubing, the refrigerant removes heat from the heated air.

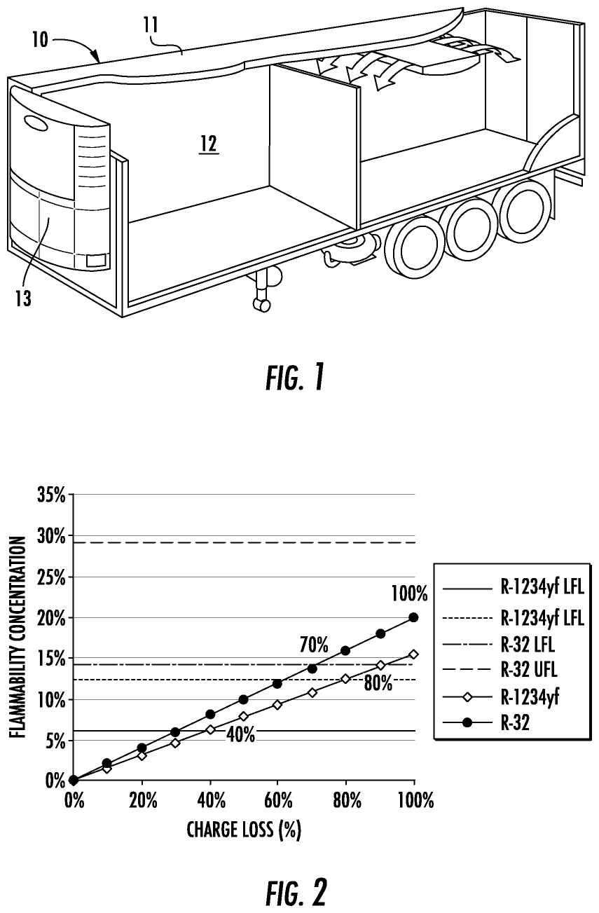

While several different types of refrigerant can be used, some refrigerants tend to have relatively high GWP whereas others tend to have relatively low GWP and, as regulations change, the use of the relatively low GWP refrigerants is becoming increasingly required. This being the case, with reference to FIG. 2, it is seen that the relatively low GWP refrigerants tend to be more flammable than the relatively high GWP refrigerants. Therefore, where the relatively low GWP refrigerants are used in TRU applications, it is typically necessary to prevent leakage of the relatively low GWP refrigerants into the flows moving through the TRU 13 and/or into the cargo area 12.

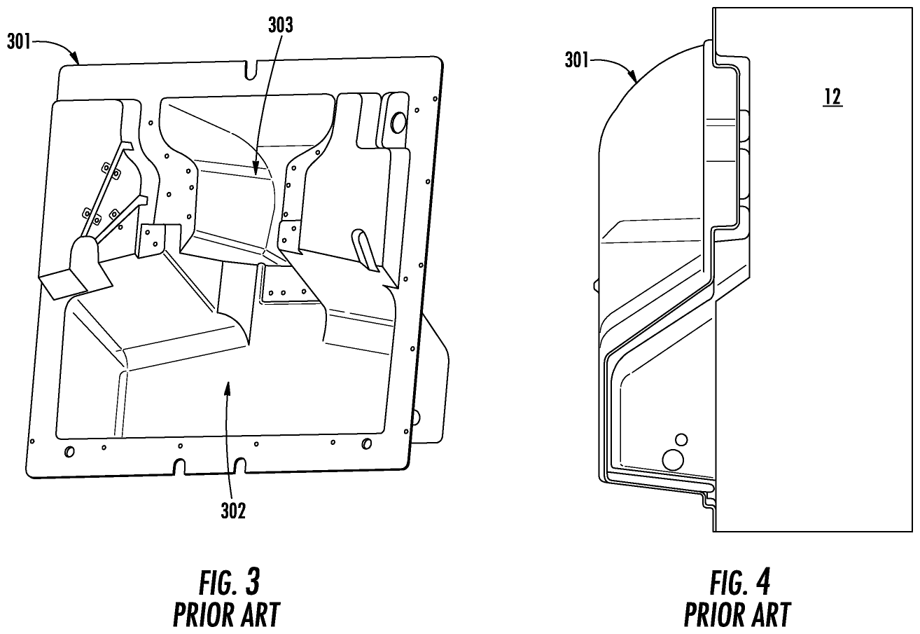

With continued reference to FIG. 1 and with additional reference to FIGS. 3 and 4, a conventional pod 301 can be provided for use with the TRU 13 to constrain and control flows of heated air from the cargo area 12 through the TRU 13 (see FIG. 1). The conventional pod 301 is attachable along its periphery to a wall of the cargo area 12 and has a convex portion that forms interior regions 302 and 303 that can respectively accommodate an evaporator of the TRU 13 and a fan that drives airflow from the cargo area 12, through an inlet defined in the wall, through the evaporator and back into the cargo area 12 through an outlet defined in the wall. As shown in FIG. 3, the interior region 302 in particular has sufficient room to accommodate an entirety of the evaporator, including the evaporator tubing and the return bend elements. The evaporator tubing is generally provided as substantially straight tubes that run across a substantial length of the evaporator. The return bend elements include return bends that connect corresponding ends of two or more evaporator tubes to one another and braze joints by which the return bends actually connect to the corresponding ends of the two or more evaporator tubes as well as additional piping and valves.

Refrigerant leaks from the evaporator tubing are uncommon, but refrigerant leaks from the return bend elements are a present issue. Thus, since the interior region 302 of the conventional pod 301 accommodates the return bend elements, leaks of refrigerant (i.e., mildly flammable, low GWP refrigerants) can occur and result in leaked refrigerant entering into the flows of air through the TRU 13 or into the cargo area 12 directly.

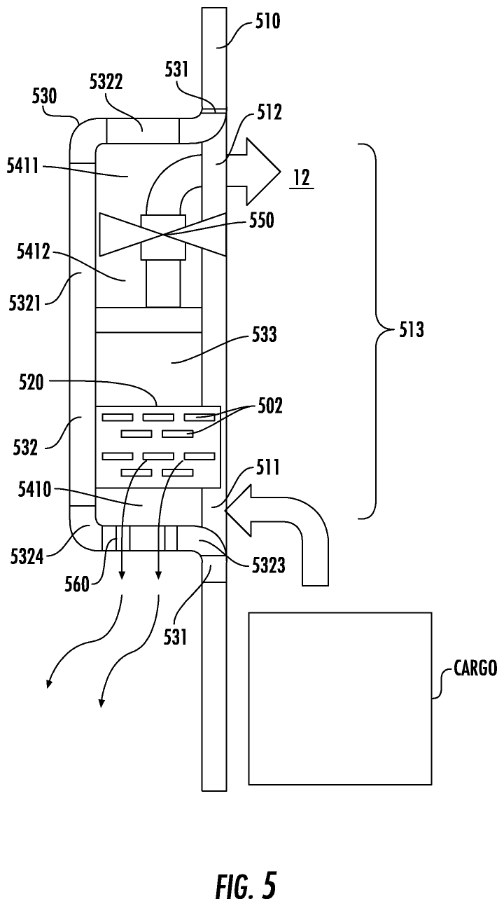

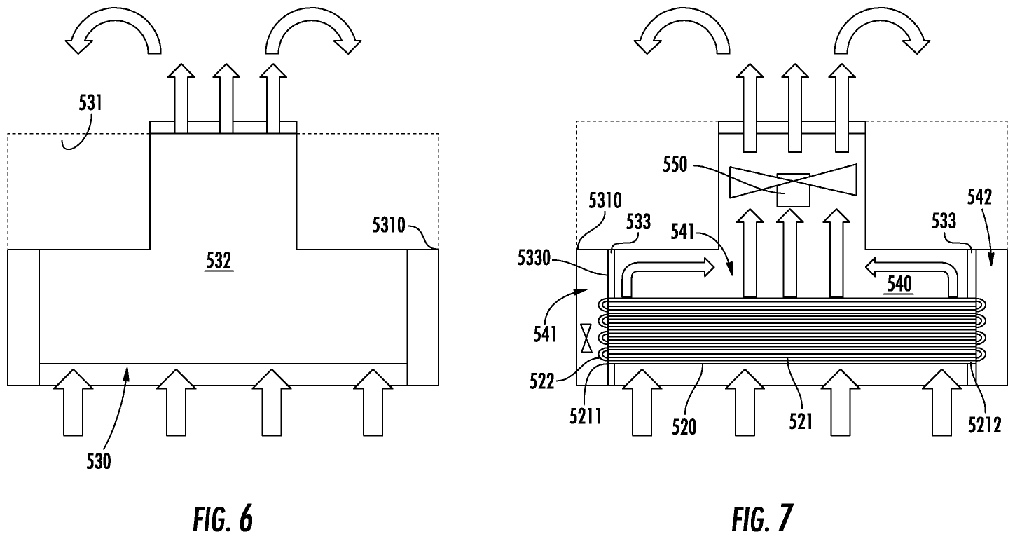

With reference to FIGS. 5-7, a transport refrigeration unit (TRU) 501 is provided and includes a cargo area wall 510 (i.e., for the cargo area 12 of FIG. 1), an evaporator 520 and a pod 530. The cargo area wall 510 is formed to define an inlet 511 and an outlet 512 that are each fluidly communicative with the cargo area 12. The evaporator 520 includes evaporator tubes 521 (see FIG. 7) and return bend elements 522. The evaporator tubes 521 are substantially straight and extend along a substantial length of the evaporator 520. The return bend elements 522 are provided at opposite end sections 5211 and 5212 of the evaporator tubes 521 and include return bends that fluidly connect corresponding ends of two or more evaporator tubes 521, brazed joints that actually connect the return bends to the evaporator tubes 521, feeder piping and valves.

The pod 530 includes peripheral flanges 531 that are attachable to the cargo area wall 510, a convex portion 532 and plate sections 533. The convex portion 532 is attached to the peripheral flanges 531 and is formed to define, with a corresponding portion 513 of the cargo area wall 510, an interior 540 (see FIG. 7). The interior 540 is communicative with the cargo area 12 through the inlet 511 and the outlet 512 and is configured and sized to accommodate the evaporator 520 and a fan 550. The fan 550 is operable to drive air flow from the inlet 511 and to the outlet 512 through the evaporator 520. The plate sections 533 are respectively secured to the opposite end sections 5211 and 5212 of the evaporator tubes 521 and to respective local portions of the peripheral flanges 531 and the convex portion 532. The plate sections 533 thus divide the interior 540 into a first interior 541 and second interiors 542.

The first interior 541 is configured and sized to accommodate the evaporator tubes 521 and the fan 550. Each of the second interiors 542 is isolated from a corresponding side of the first interior 541 and each of the second interiors 542 is sized and configured to accommodate the corresponding return bend elements 522 as well as the valves and other required piping to connect the evaporator 520 to the refrigeration system.

The plate sections 533 therefore effectively isolate the return bend elements 522 from the first interior 541. As such, leakage of refrigerant from the return bend elements 522 is prevented from flowing into the first interior 541 and from flowing into the cargo area 12 directly or indirectly.

In accordance with embodiments, the peripheral flanges 531 form a form a polygonal profile 5310 with a relatively wide, lower section that is configured and sized to surround the evaporator 520 and a relatively narrow, upper section that is configured and sized to surround the fan 550. As shown in FIG. 5, the convex portion 532 includes a forward body 5321, sidewalls 5322 extending from the peripheral flanges 531 to the forward body 5321, rounded edges 5323 at the peripheral flanges 531 and rounded edges 5324 at the forward body 5321. The sidewalls 5322 may be sized such that a width of the first interior 541 is equal to or slightly less than a width of the evaporator tubes 521.

As shown in FIG. 5, the first interior 541 includes a lower section 5410, an upper section 5411 and a central section 5412. The lower section 5410 is defined between the inlet 511 and the evaporator tubes 521. The upper section 5411 is defined between the fan 550 and the outlet 512. The central section 5412 is defined between the evaporator tubes 521 and the fan 550 and is fluidly interposed between the lower section 5410 and the upper section 5411.

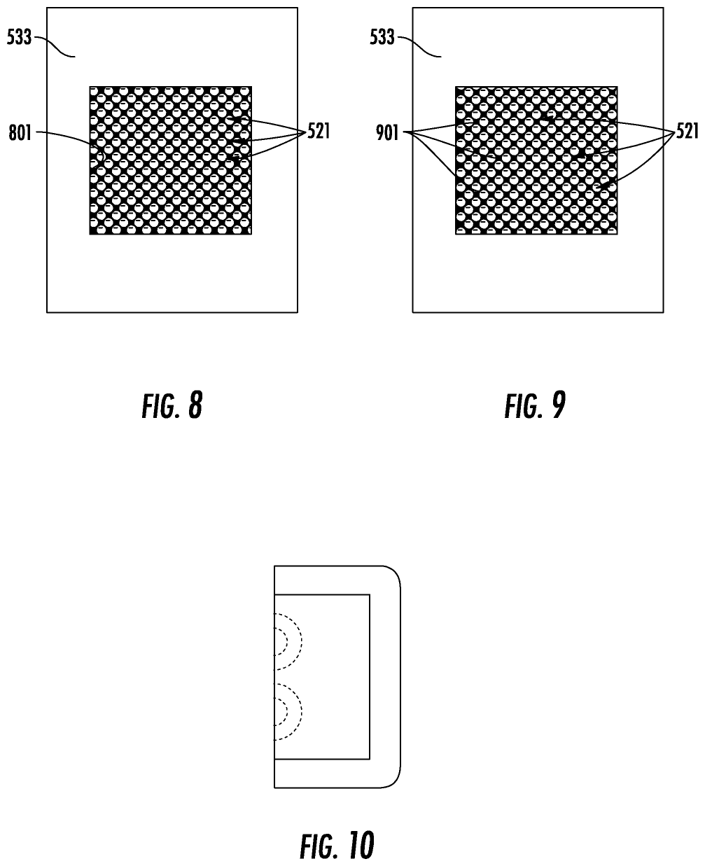

As shown in FIG. 7 and with additional reference to FIGS. 8 and 9, respective outer planes 5330 of the plate sections 533 may be substantially coplanar with respective outermost planes of the opposite end sections 5211 and 5212 of the evaporator tubes 521. Thus, substantial entireties of the return bend elements 522 can be isolated from the first interior 541. In accordance with further embodiments, the plate sections 533 can be provided as sheet metal or plastic with a single aperture 801 (see FIG. 8) or with multiple apertures 901 (see FIG. 9). The single aperture 801 can be provided to sealably surround the evaporator tubes 521 to an extent the evaporator tubes 521 are provided in a unitary body. On the other hand, the multiple apertures 901 can be provided to sealably surround each individual evaporator tube 521 in an event the evaporator tubes 521 have interstitial spaces between them.

As shown in FIG. 5, distal portions of the convex portion 532 (i.e., the portions of the convex portion 532 that surround the second interiors 542) may be formed to define drain apertures 560. Leaked refrigerant flowing out of the return bend elements 522, which is isolated from the first interior 541 within each of the second interior 542 can flow out of the second interiors 542 and toward an exterior via the drain apertures 560.

With reference to FIG. 10, the convex portion 532 may include removable panels 1001 at various locations including locations at which the removable panels 1001 would provide access to the first interior 541 and locations at which the removable panels 1001 would provide access to the second interiors 542 and the return bend elements 522 (see FIG. 10).

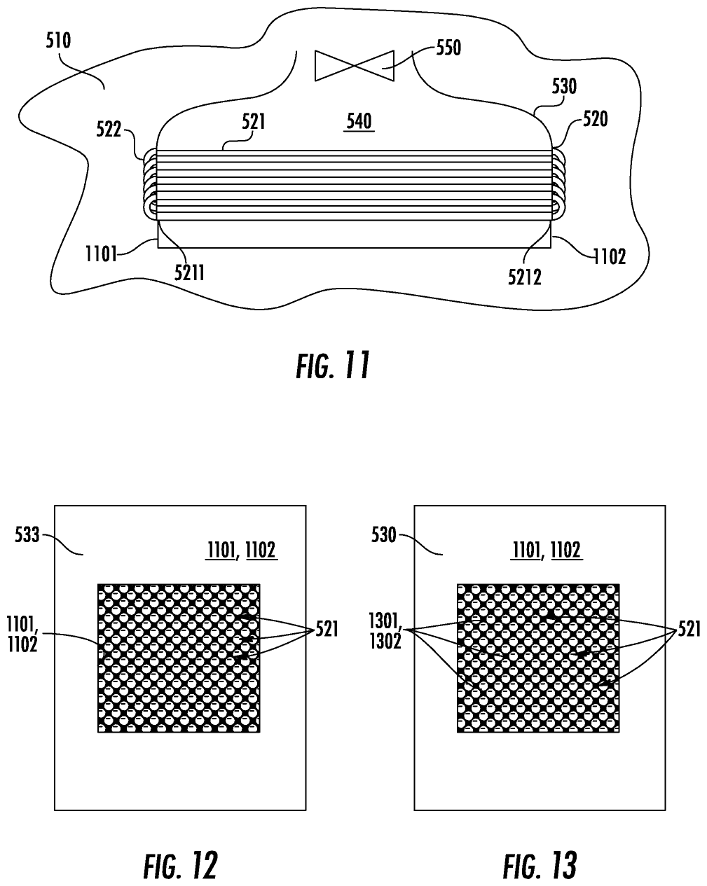

With reference to FIGS. 11-13, alternative embodiments of the pod 530 are provided in which the pod 530 itself is configured to isolate at least the return bend elements 522 from the interior 540. As shown in FIG. 11, the pod 530 is generally formed as described above to define, with the corresponding portion 513 (see FIG. 5) of the cargo area wall 510, the interior 540. The interior 540 is configured to accommodate the evaporator 520, the fan 550 and the air flow generated by the fan 550 through the evaporator 520. The opposite sides 1101, 1102 of the pod 530 are tapered around the opposite end sections 5211 and 5212 of the evaporator tubes 521 such that pod 530 itself is configured to isolate the return bend elements 522 from the interior 540.

In accordance with embodiments and, as shown in FIG. 12, the pod 530 is formed to define a first aperture 1201 and a second aperture 1202 (see FIG. 8 and the accompanying text for similar configurations). The end sections 5211 of the evaporator tubes 521 extend through the first aperture 1201 such that the return bend elements 522 associated with the end sections 5211 are isolated as a whole from the interior 540. The end sections 5212 of the evaporator tubes 521 extend through the second aperture 1202 such that the return bend elements 522 associated with the end sections 5212 are isolated as a whole from the interior 540.

In accordance with embodiments and, as shown in FIG. 13, the pod 530 is formed to define first apertures 1301 and second apertures 1302 (see FIG. 9 and the accompanying text for similar configurations). The return bend elements 522 associated with the end sections 5211 respectively extend through corresponding ones of the first apertures 1301 and are thus isolated on an individual basis from the interior 540. The return bend elements 522 associated with the end sections 5212 respectively extend through corresponding ones of the second apertures 1302 and are thus isolated on an individual basis from the interior 540.

Technical effects and benefits of the present disclosure are an elimination of a need for expensive ventilation and circulation systems that might otherwise be effectively required by regulations relating to mildly flammable, low GWP refrigerants. The pod described herein is designed such that no leak points are exposed inside a cargo box and may reduce potential false alarms, system shutdowns and loss of cargo events.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A transport refrigeration unit (TRU) comprising:
a wall defining an inlet and an outlet; and
a pod attachable to the wall to define, with a portion of the wall, an interior configured to accommodate a heat exchange portion of a heat exchanger, a fan that drives air flow from the inlet and to the outlet through the heat exchange portion and the air flow,
the pod being configured to isolate coolant flow control elements of the heat exchanger from the interior.

2. The TRU according to claim 1, wherein:
the heat exchange portion comprises evaporator tubes having first and second opposite ends, and
the coolant flow control elements comprise return bend elements that respectively connect corresponding ends of two or more evaporator tubes at one of the first and second opposite ends.

3. The TRU according to claim 2, wherein the pod defines:
a first aperture through which the first end of each of the evaporator tubes extends, and
a second aperture through which the second end of each of the evaporator tubes extends.

4. The TRU according to claim 2, wherein the pod defines:
first apertures through which the return bend elements associated with the first end extend, and
second apertures through which the return bend elements associated with the second end extend.

5. A pod for an evaporator comprising evaporator tubes and return bend elements connecting corresponding evaporator tube ends, the pod comprising:
peripheral flanges which are attachable to a wall of a cargo area;
a convex portion formed to define, with a portion of the wall, an interior to accommodate the evaporator tubes and a fan,
the interior being fluidly communicative with the cargo area through an inlet and an outlet defined in the wall, and
the fan drives air flow from the inlet to the outlet and through the evaporator tubes; and plate sections respectively secured to opposite end sections of the evaporator tubes and respective local portions of the peripheral flanges and the convex portion to isolate the return bend elements from the interior.

6. The pod according to claim 5, wherein the return bend elements comprise:
return bends; and
brazed joints that connect the return bends to the corresponding ends of the two or more evaporator tubes.

7. The pod according to claim 5, wherein the peripheral flanges form a polygonal profile and the convex portion comprises rounded edges.

8. The pod according to claim 5, wherein the interior comprises:
a lower section defined between the inlet and the evaporator tubes;
an upper section defined between the fan and the outlet; and
a central section defined between evaporator tubes and the fan.

9. The pod according to claim 5, wherein:
respective outer planes of the plate sections are coplanar with respective outermost planes of the opposite end sections of the evaporator tubes, or
the plate sections are respectively formed to define apertures through which the return bend elements are connectable with the corresponding evaporator tube ends.

10. The pod according to claim 5, wherein:
the plate sections respectively define, with respective distal portions of the peripheral flanges and the convex portion, distal interiors isolated from the interior, and
the distal portions of the convex portion define apertures through which the distal interiors are communicative with an exterior of the cargo area.

11. The pod according to claim 5, wherein the convex portion comprises removable panels.

12. A transport refrigeration unit (TRU) comprising:
a wall defining an inlet and an outlet between a cargo area and an exterior;
an evaporator; and
a pod comprising:
peripheral flanges attachable to the wall;
a convex portion defining, with a portion of the wall, an interior communicative with the cargo area through the inlet and the outlet and configured to accommodate the evaporator and a fan that drives air flow from the inlet and to the outlet through the evaporator; and
plate sections respectively secured to opposite end sections of evaporator tubes of the evaporator and respective local portions of the peripheral flanges and the convex portion to divide the interior into:
a first interior configured to accommodate the evaporator tubes and the fan, and
second interiors isolated from the first interior and configured to accommodate return bend elements of the evaporator.

13. The pod according to claim 12, wherein the return bend elements comprise:
return bends; and
brazed joints that connect the return bends to corresponding ends of the two or more evaporator tubes.

14. The pod according to claim 12, wherein the peripheral flanges form a polygonal profile and the convex portion comprises rounded edges.

15. The pod according to claim 12, wherein a width of the first interior is equal to or slightly less than a width of the evaporator tubes.

16. The pod according to claim 12, wherein the first interior comprises:
a lower section defined between the inlet and the evaporator tubes;
an upper section defined between the fan and the outlet; and
a central section defined between evaporator tubes and the fan.

17. The pod according to claim 12, wherein respective outer planes of the plate sections are coplanar with respective outermost planes of the opposite end sections of the evaporator tubes.

18. The pod according to claim 12, wherein the plate sections are respectively formed to define apertures through which the return bend elements are connectable with the corresponding evaporator tubes.

19. The pod according to claim 12, wherein the distal portions of the convex portion define apertures through which the second interiors are communicative with an exterior of the cargo area.

20. The pod according to claim 12, wherein the convex portion comprises removable panels.
